(19) United States
(12) Patent Application Publication
(10) Pub. No.: US 2011/0265131 A1
(43) Pub. Date: Oct. 27, 2011

(54) Recording and Playback of Video Using A Live TV Buffer

(75) Inventor: Jerry Wayne Chappell, Duluth, GA (US)

(73) Assignee: Cox Communications, Inc., Atlanta, GA (US)

(21) Appl. No.: 12/767,371

(22) Filed: Apr. 26, 2010

(51) Int. Cl. H04N 7/173

(52) U.S. Cl. 725/89

(57) ABSTRACT

Methods and systems for live recording of video on a set-top box of a cable television system include receiving a video signal on a first channel of the set-top box. The set-top box does not include a hard disk drive. Video is displayed on a television corresponding to the video signal. The video signal received on the first channel is recorded in a buffer memory in the set-top box. The display of video on the television is then paused, the video signal being recorded in the buffer memory when the display of video is paused. The display of video on the television is then resumed, the display of the video on the television being resumed from the point at which the display of the video was paused.

### BACKGROUND

Cable television systems are widely used to deliver television signals to people's homes. In a cable television system, television signals are typically transmitted from satellites which orbit the earth to cable television system control stations. The cable television control stations, known as head ends, process the satellite signals as well as television signals from local television stations, and deliver television signals to people's homes via a network of cables.

A set-top box is a device that is used to connect a television signal to a television. The set-top box turns the television signal into content that is displayed on the television screen. When the television is an analog TV, the set-top box converts received television signals, typically received over a cable, into frequencies than can be viewed on the analog TV. When the television is a digital TV, a set-top box may provide digital tuning capability and may also provide additional services such as a program guide and an interface to the Internet. In addition, many set-top boxes used with digital TV also provide digital video recording functionality.

A digital video recorder (DVR) is a device that records live video in a digital format. Because video is recorded in digital format, DVRs provide features that analog recording devices, such as video cassette recorders, cannot provide. Among these features is the ability to pause the display of live video while simultaneously recording live video. DVRs typically include a hard disk drive and are capable of recording many hours of video.

Set-top boxes used for digital TV include models that provide built-in DVR functionality and models that do not provide DVR functionality. The set-top box models that provide DVR functionality are typically more expensive than the models that do not provide DVR functionality, mainly because of the added cost of a hard disk drive. Cable television users that would like to use some of the features provided with DVRs, for example, the ability to pause the recording of live video, are often forced to pay more than they would like or can afford in order to obtain these features.

It is with respect to these and other considerations that the present invention has been made.

### SUMMARY

Embodiments of the invention solve the above and other problems by using a live TV buffer to provide DVR functionality in a set-top box, without the use of a hard disk drive. The live TV buffer is a buffer memory that is included in the set-top box. When a channel is selected on a television set controlled by the set-top box, video received on the channel is recorded in the live TV buffer. Using a remote control or other means for interacting with the set-top box, a viewer can pause the display of live video in order to deal with a short-term interruption, such as answering the telephone. Live video is recorded in the set-top box when the display of live video is paused. When the viewer is ready to resume viewing, the video is resumed from the point at which the live video was paused. The video that is displayed when the video is resumed originates from the live TV buffer, from the location of buffer memory at which the live video was paused.

One embodiment is directed to a method for live recording of video implemented on a set-top box of a cable television system. A video signal is received on a first channel of the set-top box. The set-top box is an electronic computing device. The set-top box does not include a hard disk drive. The set-top box includes a plurality of channels. The video signal is received over a cable that is part of the cable television system.

Video is displayed on the television corresponding to the video signal. The video signal received on the first channel is recorded in a buffer memory in the set-top box. The display of video on the television is then paused, the video signal being recorded in the buffer memory when the display of video is paused. The display of video is then resumed with the display of the video on the television being resumed from the point at which the display of the video was paused.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows a simplified block diagram of a cable services system architecture in which embodiments of the invention may be implemented.

FIG. 2 shows a flowchart of a method for using a live TV buffer to implement DVR functionality in a set-top box.

FIG. 3 shows a flowchart of another method for using a live TV buffer to implement DVR functionality in a set-top box.

### DETAILED DESCRIPTION

The present application is directed to systems and methods for providing digital video recording (DVR) functionality in a set-top box without the use of a hard disk drive. Using the systems and methods, live video is recorded in a live TV buffer of the set-top box. The video is also displayed on a television set. The display of video on the television set can be paused and then resumed from the location in the live TV buffer from which the video was paused. In addition, other DVR functionality, including rewind/playback of recorded video and the ability to fast forward through commercials is provided.

The live TV buffer is a buffer memory that is included in the set-top box. Live video is recorded in the live TV buffer for a channel selected on the set-top box. During the viewing of live video on a television, there are many occasions when a viewer would like to pause the live video and then resume the video at a later time. For example, the telephone may ring or someone may come into the viewing room and want to talk with the viewer, or the viewer would like to get a snack, etc. In each of these cases, the viewer would like to be able to address the issue at hand and then resume viewing from the point at which the interruption occurred. In this disclosure, the terms viewer and user are used interchangeably.

With the systems and methods described, the viewer can press a pause button on a remote control device of the set-top box to pause the display of live video. Alternatively, the viewer can press a control on the remote control device that is associated with pausing the display of live video. Pausing the display of live video corresponds to freezing the display of video on the television set. While the display of live video is paused, live video is still being recorded in the live TV buffer. Other suitable means for interacting with the set-top box for pausing the display of live video may be utilized, such as a keyboard associated with the set-top box, touch screen functionality, and the like.

When the viewer is ready to resume the display of video, the viewer presses a play button on the remote control. Alternatively, the viewer can press a control on the remote control device that is associated with resuming the display of video. Other means of resuming the display of video are possible, for example, toggling the pause button or utilizing some other means for interacting with the set-top box, for example, by a keyboard associated with the set-top box, touch screen functionality, and the like.

When the viewer resumes the display of video, the video is resumed from the location in the live TV buffer from which the display of video was paused. At the same time, live video continues to be recorded in the live TV buffer. For example, if the viewer is watching a television program that runs for 30 minutes, the viewer would be able to resume watching the program from where the program was paused and, depending on the size of the live TV buffer, continue viewing until the end of the program.

The amount of video that can be recorded in the live TV buffer is dependent on the size of the live TV buffer. The amount of buffer memory used for a live TV buffer may vary depending on the manufacturer or model of the set-top box. In general, the size of the live TV buffer is large enough to provide DVR features to handle relatively short interruptions of viewing. Because of the cost of memory, the recording limit for the live TV buffer is generally much less than that provided in a DVR device that includes a hard disk drive. An example recording limit is 30 minutes, but it may be as low as 10 or 15 minutes in order to reduce the cost of the set-top box. Other recording time limits are possible.

The buffer memory in the live TV buffer is volatile, so that video stored in the live TV buffer is lost when power is turned off. In addition, whenever a viewer selects a different channel to watch, video is recorded in the live TV buffer for the newly selected channel and video recorded for the previous channel is lost. Furthermore, as mentioned, the recording capacity of the live TV buffer is short compared to typical recording times of DVRs with hard disk drives. However, the cost of a set-top box with a live TV buffer for implementing DVR functionality is generally significantly less than the cost of a DVR with a hard disk drive.

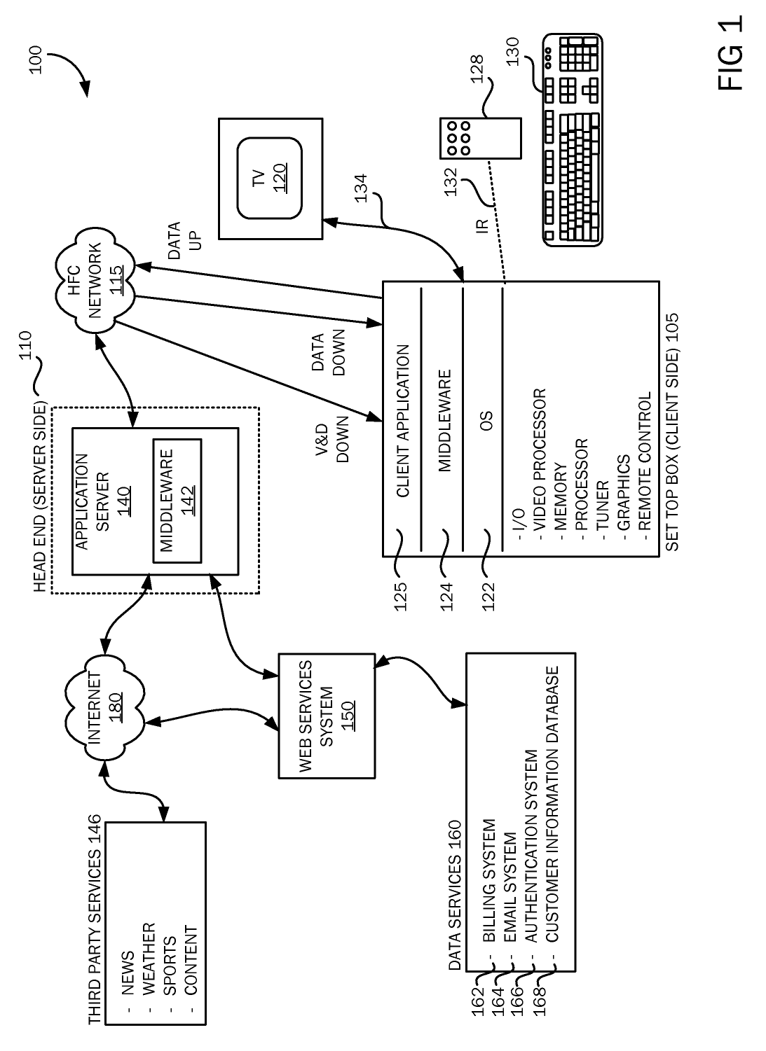

FIG. 1 shows an example system 100 that supports recording and playback of video using a live TV buffer in a set-top box in a cable television system. Referring to FIG. 1, digital and analog video programming, information content and interactive television services are provided via a hybrid fiber coax (HFC) network 115 to a television set 120 for consumption by a cable television/services system customer. As is known to those skilled in the art, HFC networks 115 combine both optical fiber and coaxial cable lines. Typically, optical fiber runs from the cable head end 110 to neighborhoods of 500 to 2,000 customers. Coaxial cable runs from the optical fiber feeders to each customer. According to embodiments of the present invention, the functionality of the HFC network 115 allows for efficient bidirectional data flow between the client-side set-top box 105 and the server-side application server 140 of the present invention.

According to embodiments of the present invention, the CATV system 100 is in the form of a distributed client-server computing system for providing video and data flow across the HFC network 115 between server-side services providers (e.g., cable television/services providers) via a server-side head end 110 and a client-side customer via a client-side set-top box (STB) functionally connected to a customer receiving device, such as the television set 120. As is understood by those skilled in the art, modern CATV systems 400 may provide a variety of services across the HFC network 115 including traditional digital and analog video programming, telephone services, high speed Internet access, video-on-demand, and information services.

On the client side of the CATV system 100, digital and analog video programming and digital and analog data are provided to the customer television set 120 via the set-top box (STB) 105. Interactive television services that allow a customer to input data to the CATV system 100 likewise are provided by the STB 105. As illustrated in FIG. 1, the STB 105 is a multipurpose computing device having a computer processor, memory and an input/output mechanism. The input/output mechanism receives input from server-side processes via the HFC network 115 and from customers via input devices such as the remote control device 128 and the keyboard 130. The remote control device 128 and the keyboard 130 may communicate with the STB 105 via a suitable communication transport such as the infrared connection 132. The STB 105 also includes a video processor for processing and providing digital and analog video signaling to the television set 120 via a cable communication transport 134. A multi-channel tuner is provided for processing video and data to and from the STB 105 and the server-side head end system 110, described below.

The STB 105 also includes an operating system 122 for directing the functions of the STB 105 in conjunction with a variety of client applications 126. For example, if a client application 125 requires a news flash from a third-party news source to be displayed on the television 120, the operating system 122 may cause the graphics functionality and video processor of the STB 105, for example, to output the news flash to the television 120 at the direction of the client application 126 responsible for displaying news items.

Because a variety of different operating systems 122 may be utilized by a variety of different brands and types of set-top boxes, a middleware layer 124 is provided to allow a given software application to be executed by a variety of different operating systems. According to an embodiment of the present invention, the middleware layer 124 may include a set of application programming interfaces (API) that are exposed to client applications 126 and operating systems 122 that allow the client applications to communicate with the operating systems through common data calls understood via the API set. As described below, a corresponding middleware layer is included on the server side of the CATV system 100 for facilitating communication between the server-side application server and the client-side STB 105. According to one embodiment of the present invention, the middleware layer 442 of the server-side application server and the middleware layer 124 of the client-side STB 105 format data passed between the client side and server side according to the Extensible Markup Language (XML).

The set-top box 105 passes digital and analog video and data signaling to the television 120 via a one-way communication transport 134. Alternatively, two-way communication may also be accomplished, for example, via high definition multimedia interfaces (HDMI). The STB 105 may receive video and data from the server side of the CATV system 100 via the HFC network 115 through a video/data downlink and data via a data downlink. The STB 105 may transmit data from the client side of the CATV system 100 to the server side of the CATV system 100 via the HFC network 115 via one data uplink. The video/data downlink is an “in band” downlink that allows for digital and analog video and data signaling from the server side of the CATV system 100 through the HFC network 115 to the set-top box 105 for use by the STB 105 and for distribution to the television set 120. As is understood by those skilled in the art, the “in band” signaling space operates at a various frequencies, for example, between 54 and 1000 megahertz. The signaling space is generally divided into 6 megahertz channels in which may be transmitted a single analog signal or a greater number (e.g., up to ten) digital signals.

The data downlink and the data uplink, illustrated in FIG. 1, between the HFC network 115 and the set-top box 105 comprise “out of band” data links. As is understand by those skilled in the art, the “out of band” frequency range generally lies between zero and 54 megahertz. According to embodiments of the present invention, data flow between the client-side set-top box 105 and the server-side application server 140 is typically passed through the “out of band” data links. Alternatively, an “in band” data carousel may be positioned in an “in band” channel into which a data feed may be processed from the server-side application server 140 through the HFC network 115 to the client-side STB 105. Operation of data transport between components of the CATV system 100, described with reference to FIG. 1, is well known to those skilled in the art.

According to one embodiment data passed between the CATV system backend components such as the head end 110 and the CATV system front end components such as the STB 105 may be passed according to the Data Over Cable Service Interface Specification (DOCSIS). As is well known to those skilled in the art, DOCSIS provides for a mechanism for data transport over a cable system such as the CATV 100, illustrated in FIG. 1. Among other things, DOCSIS allows for the passing of digital communications and Internet connectivity over an HFC network 115.

Referring still to FIG. 1, the head end 110 of the CATV system 100 is positioned on the server side of the CATV system and includes hardware and software systems responsible for originating and managing content for distributing through the HFC network 115 to client-side STBs 105 for presentation to customers via televisions 120. As described above, a number of services may be provided by the CATV system 100, including digital and analog video programming, interactive television services, telephone services, video-on-demand services, targeted advertising, and provision of information content.

The application server 140 is a general-purpose computing system operative to assemble and manage data sent to and received from the client-side set-top box 105 via the HFC network 115. As described above with reference to the set-top box 105, the application server 140 includes a middleware layer 142 for processing and preparing data from the head end of the CATV system 100 for receipt and use by the client-side set-top box 105. For example, the application server 140 via the middleware layer 142 may obtain data from third-party services 146 via the Internet 140 for transmitting to a customer through the HFC network 115 and the set-top box 105. For example, a weather report from a third-party weather service may be downloaded by the application server via the Internet 144. When the application server 140 receives the downloaded weather report, the middleware layer 142 may be utilized to format the weather report for receipt and use by the set-top box 105. According to one embodiment of the present invention, data obtained and managed by the middleware layer 142 of the application server 140 is formatted according to the Extensible Markup Language and is passed to the set-top box 105 through the HFC network 115 where the XML-formatted data may be utilized by a client application 126 in concert with the middleware layer 124, as described above. XML is only one example formatting language or type and other formatting languages or types may also be utilized. As should be appreciated by those skilled in the art, a variety of third-party services data, including news data, weather data, sports data and other information content may be obtained by the application server 140 via distributed computing environments such as the Internet 144 for provision to customers via the HFC network 115 and the set-top box 105.

According to embodiments of the present invention, the application server 140 obtains customer profile data from services provider data services 160 for preparing a customer profile that may be utilized by the set-top box 105 for tailoring certain content provided to the customer. According to an embodiment of the present invention, a customer profile may include communications applications provisioned on networked STBs, as well as, designations of individual STBs in a home, business or facility (e.g., “kitchen STB,” “bedroom STB,” “office STB,” and the like).

As illustrated in FIG. 1, the services provider data services 160 include a number of services operated by the services provider of the CATV system 100 which may include data on a given customer. For example, a billing system 162 may include information such as a customer's name, street address, business identification number, Social Security number, credit history, and information regarding services and products subscribed to by the customer. An electronic mail system 164 may contain information such as electronic mail addresses, high-speed Internet access subscription information and electronic mail usage data. An authentication system 166 may include information such as secure user names and passwords utilized by customers for access to network services. The customer information database 168 may include general information about customers such as place of employment, business address, business telephone number and demographic information such as age, gender, educational level, and the like. As should be understood by those skilled in the art, the disparate data services systems 162, 164, 166, 168 are illustrated as a collection of data services for purposes of example only. The example data services systems comprising the data services 160 may operate as separate data services systems, which communicate with a web services system (described below) along a number of different communication paths and according to a number of different communication protocols.

Referring still to FIG. 1, a web services system 150 is illustrated between the application server 140 and the data services 160. According to embodiments of the present invention, the web services system 150 serves as a collection point for data requested from each of the disparate data services systems comprising the data services 160. When the application server 140 requires customer profile data from one or more of the data services 160 for preparation or update of a customer profile, the application server 140 passes a data query to the web services system 150. The web services system formulates a data query to each of the available data services systems for obtaining any available data for a given customer as identified by a set-top box identification associated with the customer. The web services system 150 serves as an abstraction layer between the various data services systems and the application server 140. That is, the application server 140 is not required to communicate with the disparate data services systems, nor is the application server 140 required to understand the data structures or data types utilized by the disparate data services systems. The web services system 150 is operative to communicate with each of the disparate data services systems for obtaining necessary customer profile data. The customer profile data obtained by the web services system is assembled and is returned to the application server 140 for ultimate processing via the middleware layer 142, as described above.

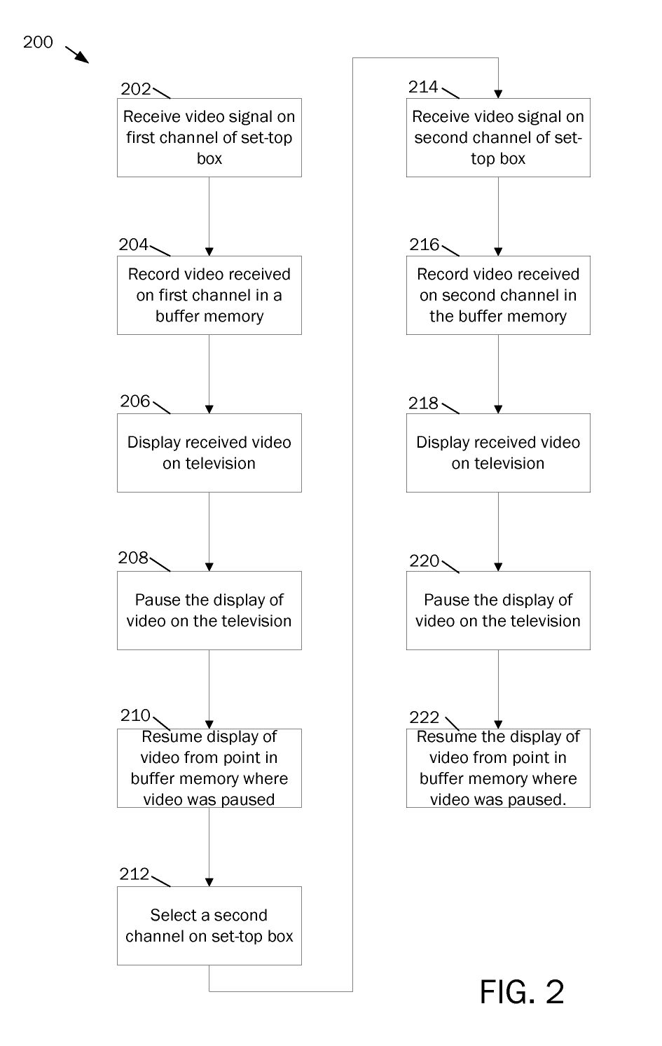

FIG. 2 shows an example flowchart for a method 200 for implementing DVR functionality in a set-top box using buffer memory in the set-top box. At operation 202, a video signal is received on a first channel of the set-top box, for example, set-top box 105. In this example, the video signal is received over HFC network 115 from head-end server 140.

At operation 204, the video signal is recorded in a live TV buffer of the set-top box 105. The live TV buffer is a buffer memory, recording the video signal as it is received at set-top box 105. At the same time that the video signal is recorded in the live TV buffer, at operation 206, the video is displayed on a television set, for example, on television set 120.

At operation 208, a viewer watching the video on the television set pauses the video, freeze framing the video on the television set. The viewer typically pauses the video by pressing a pause button, or a control with freeze-frame functionality on a remote control included with set-top box 105. The viewer may want to pause the video for any number of reasons. For example, the viewer may need to speak to someone and does not want to miss any video or the viewer may desire to get a snack, answer a telephone call, etc.

While the video is paused, live video is still being recorded in the live TV buffer. When reviewer is ready to resume watching television, at operation 210, the user typically presses a play button or a control with resume functionality, on the remote control for set-top box 105. In some examples, the viewer may simply press the pause button again to toggle pause mode off. Other user interface methods for resuming paused video are possible.

When the display of video is resumed at operation 210, video is resumed from the point in the live TV buffer at which the display of video was paused. Because the video is resumed from the point in live TV buffer at which the display of video was paused, the viewer does not miss any of the video. In addition, live video is still being recorded in the live TV buffer.

At operation 210, the viewer selects a second channel on set-top box 105. The viewer may have finished viewing a program or event on the first channel or may just decide to watch a different channel. As soon as the viewer selects the second channel, at operation 214 a video signal is received at the second channel and, at operation 216, the video signal is recorded in the live TV buffer. The video from the second channel is also displayed on the television set 120, at operation 218.

When the video signal from the second channel is recorded in the live TV buffer at operation 216, the video recorded from the first channel in the live TV buffer is lost and no longer available to the viewer. Thus, the live TV buffer constitutes temporary storage, only recording and playing back video for one channel at a time. When a channel is changed, the video recorded from the previous channel is lost. Similarly, when the live TV buffer has reached its capacity for a given channel, recording wraps around in the live TV buffer and overwrites previously recorded video for the channel.

At operation 220, the viewer pauses the display of video for the second channel. The video for the second channel is paused in the same manner as for the first channel, typically by pressing a pause button on the remote control of set-top box 105. Video received on the second channel is still recorded in the live TV buffer when the display of video on the second channel is paused.

At operation 222, the viewer resumes the display of video for the second channel. When the display of video is resumed for the second channel, the display is resumed from the point in the live TV buffer from which the display of video was paused.

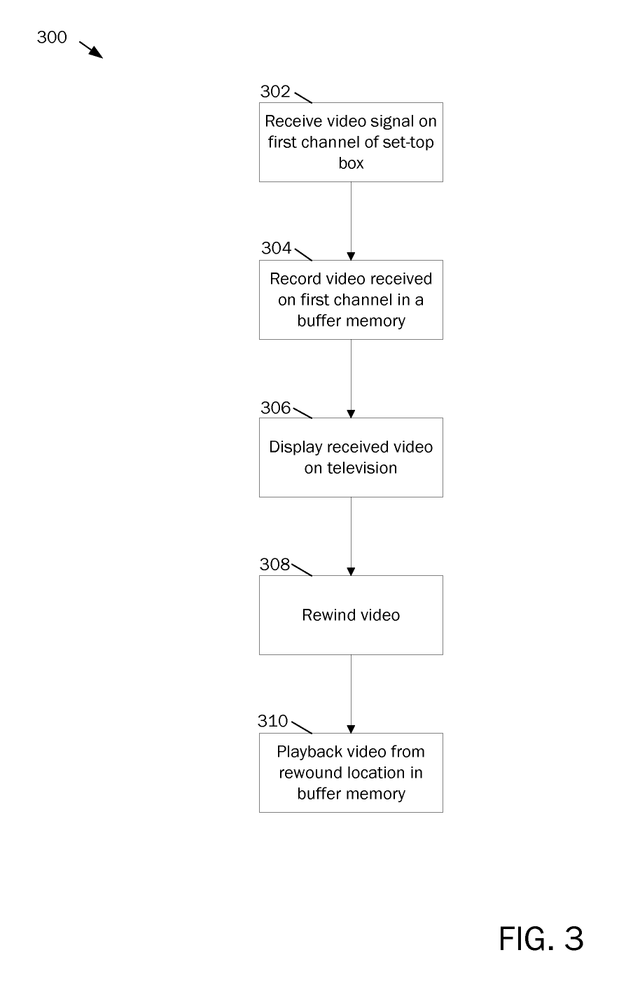

FIG. 3 shows an example flowchart for another method 300 for implementing DVR functionality in a set-top box 105 using buffer memory in the set-top box. Operations 302-306 for this method are the same as for operations 202-206 for method 200. However, in method 300, video is rewound and played back instead of being paused. At operation 302, a video signal is received on a first channel of set-top box 105. At operation 304, the video signal is recorded in a live TV buffer of the set-top box 105. At operation 306, the video is displayed on television set 120.

At operation 308, the viewer rewinds video previously recorded in the live TV buffer for the first channel. Rewinding, in this example refers to selecting a location in the live TV buffer corresponding to a previous point in the recorded video. The viewer typically selects this location via a remote control for set-top box 105. For example, the user may select the location in the live TV buffer corresponding to a time of day that the video was recorded.

At operation 310, video is played back from the point in the live TV buffer from which it was rewound. Live video for the first channel is still being recorded when the video is rewound and played back.

The various embodiments described above are provided by way of illustration only and should not be construed to limiting. Various modifications and changes that may be made to the embodiments described above without departing from the true spirit and scope of the disclosure.

What is claimed is:

1. A method for live recording of video implemented on a set-top box of a cable television system, the method comprising:
receiving a video signal on a first channel of the set-top box, the set-top box being an electronic computing device, the set-top box not including a hard disk drive, the set-top box including a plurality of channels, the video signal being received over a cable that is part of the cable television system;
displaying video on the television corresponding to the video signal;
recording the video signal received on the first channel in a buffer memory in the set-top box; and
pausing the display of video on the television, the video signal being recorded in the buffer memory when the display of video is paused.

2. The method of claim 1, further comprising resuming the display of video on the television, the display of the video on the television being resumed from the point at which the display of the video was paused, there being a continuity of the display of the video on the television.

3. The method of claim 2, wherein the video displayed on the television, when the display of video is resumed, originates from the buffer memory of the set-top box.

4. The method of claim 3, wherein the video signal received on the first channel continues to be recorded in the buffer memory when the display of the video is resumed, the video signal being recorded starting at a first location of the buffer memory, the video being displayed originating from a second location of the buffer memory, the second location being different than the first location.

5. The method of claim 1, further comprising selecting a second channel for the display of video, the recording of the video signal received on the first channel being stopped when the second channel is selected.

6. The method of claim 5, further comprising recording the video signal received on the second channel in the buffer memory when the second channel is selected.

7. The method of claim 6, wherein the recording of the video signal received on the second channel overwrites in the buffer memory the video signal recorded from data received on the first channel.

8. The method of claim 1, further comprising stopping the recording of the video signal received on the first channel, selecting a location of the recorded video in the buffer memory from which to playback the video and playing back the video on the television.

9. The method of claim 8, wherein the location of the recorded video from which to playback the video can be any point in the recorded video.

10. A set-top box comprising a processor and memory, the set-top box including instructions that when executed by the processor cause the set-top box to:
receive a video signal on a first channel of the set-top box, the set-top box being an electronic computing device, the set-top box not including a hard disk drive, the first channel being one of plurality of channels in the set-top box, the video signal being received over a cable that is part of a cable television system;
display video on the television corresponding to the video signal;
record the video signal received on the first channel in a buffer memory in the set-top box; and
pause the display of the video on the television upon an action of a user, the video signal being recorded in the buffer memory when the display of video is paused.

11. The set-top box of claim 10, further including instructions to resume the display of video on the television upon an action of the user, the video being displayed originating from a first location in the buffer memory.

12. The set-top box of claim 11, wherein the first location in the buffer memory corresponds to the location in buffer memory at which the video signal was last recorded when the display of video was paused.

13. The method of claim 12, wherein the video signal received on the first channel continues to be recorded in the buffer memory when the display of video is resumed.

14. The method of claim 10, further including instructions for selecting a second channel on the television for the display video, the recording of the video signal received on the first channel being stopped when the second channel is selected.

15. The method of claim 14, further including instructions for recording the video signal received on the second channel in the buffer memory when the second channel is selected.

16. The method of claim 15, wherein the recording of the video signal received on the second channel overwrites in the buffer memory the video signal recorded from data received on the first channel.

17. The method of claim 10, further including instructions for stopping the recording of video received on the first channel, selecting a location of the recorded video from which to playback the video and playing back the video on the television.

18. The method of claim 17, wherein the location of the recorded video from which to playback the video can be any location in the recorded video.

19. A computer-readable storage medium comprising instructions that, when executed by the processing unit of a set-top box, cause the processing unit to:
receive a video signal on a first channel of the set-top box, the set-top box being an electronic computing device, the set-top box not including a hard disk drive, the first channel being one of plurality of channels in the set-top box, the video signal being received over a cable that is part of a cable television system;
display video on the television corresponding to the video signal;
record the video signal received on the first channel in a buffer memory in the set-top box;
pause the display of video on the television upon an action of a user, the video signal being recorded in the buffer memory when the display of video is paused; and
resume the display of video on the television upon an action of the user, the video being displayed originating from a first location in the buffer, first location in the buffer memory corresponding to the location in buffer memory at which the video signal was last recorded when the display of video was paused, the video signal received on the first channel continuing to be recorded in the buffer memory when the display of video is resumed.

20. The computer readable storage medium of claim 19, further including instructions that, when executed by the processing unit of a set-top box, cause the processing unit to:
select a second channel on the television for the display of video, the recording of the video signal received on the first channel being stopped when the second channel is selected; and
record the video signal received on the second channel in the buffer memory when the second channel is selected, the recording of the video signal received on the second channel overwriting in the buffer memory the video signal recorded from data received on the first channel.
